(19) United States
(12) Patent Application Publication
(10) Pub. No.: US 2017/0050406 A1
(43) Pub. Date: Feb. 23, 2017

(54) Two-sided Shapeable Fabric Manifold Used Alone or in Combination, Hung Freely as Aerial Sculpture or Decorative Paneling System, or Used Singly as a Semi-Rigid Display Stand or Decorative Accessory

(71) Applicant: Kay Ann Conti, Trenton, NJ (US)

(72) Inventor: Kay Ann Conti, Trenton, NJ (US)

(21) Appl. No.: 14/831,180

(22) Filed: Aug. 20, 2015

(51) Int. Cl. B32B 3/06; B32B 7/08; B32B 5/26; B32B 7/12

(52) U.S. Cl. CPC B32B 3/06; B32B 7/12; B32B 7/08; B32B 5/26; B32B 2262/103; B32B 2260/021; B32B 2307/764; B32B 2307/71; B32B 2307/73; B32B 2307/3065; B32B 2451/00; B32B 2601/00; B32B 2590/00; B32B 2559/00

(57) ABSTRACT

A decorative system constituting a shapeable fabric manifold, displaying decorative fabrics on either face and containing internal shapeable elements which allow the manifold to be bent, serving as a decorative display stand, wall-mounted-display, or interconnected as a free-hanging rigid sculpture. The first two embodiments of the invention describe two methods of manufacture with bendable stays or through use of a bendable screen or web interfacing. Individual manifolds may serve as table-top display stands, long fabric manifolds can be wall-mounted to substitute for a swag in a window curtain treatment, while interconnection of bendable manifolds allows for the construction of large light-weight three-dimensional sculptural forms to hang in atriums and public places. Interconnected systems of decorative manifolds can be constructed as spatial dividers, as well as decorative wind and/or sun-screens. Manifolds may constructed to serve as “advertising banners” or as contoured fabric frames for oil-paintings on canvas.

### FIELD OF THE INVENTION

The present invention relates to shapeable decorative textile manifolds which can be used alone or in combination, to serve as decorative display stands, wall-mounted fabric displays, or freely hung as aerial sculptures and decorative accessories.

### BACKGROUND OF THE INVENTION

The current invention constitutes an innovation expanding the use of fabric as an independent sculptural element for use in interior design. It constitutes a new utility for decorative fabric which requires no new technologies and can be easily manufactured with no specialized industrial processes or equipment.

Decorative textile design goes back to the very beginnings of history in Mesopotamia, Asia, and China where the decorative elements of fabric often functioned as a means of ostentation by the wealthy. Textiles were rarely used “for art only.” Fabric is generally intended for functional uses, and is artfully embellished to display the user's wealth and taste. The importance of this invention is that, in addition to its commercial and utilitarian uses, it promotes a new use of decorative fabric as “art in itself.”

Several classes of non-utilitarian fabric art are pre-existing. Fabrics, felts in particular, have long been shaped into rigid sculptural forms through various treatments. Fabric vase-making incorporates many of the characteristics of the current invention, such as stabilized semi-rigid shapes joined into three-dimensional ornamental or sculptural structures. Felt flowers are constructed with flexible wire stays, but are not intended for hanging, nor for independent two-sided displays. Fabric mobiles, such as those made from ornate kites, create free-hanging decorative sculptures of silks or synthetic fibers in which the independent elements are constructed around rigid structural members. Similarly, oriental paper-folding techniques have been extended to fabric-based wall art, but do not incorporate stays of any kind. Similar to kites are those forms of functional fabric art which contain rigid reinforced elements, such as umbrellas and different forms of illuminated “Chinese Lanterns,” and ornately decorated dressing screens. All of these stretch fabric over a rigid or semi-rigid element, none of which are shapeable by the user for aesthetic purposes during the installation. The same can be said of large fabric sculptural forms which are traditionally created by Chinese artists for light-weight New Years' displays using stretched silks and other fabrics over bamboo or rigid metal frameworks.

The current invention allows a designer to use flexible decorative fabric elements to create free-hanging fabric sculpture in any number of ways. Single elements can be hung against the wall as single twisted “ribbons” as in FIG. 7, as single sculptural banners as in FIG. 6, or as large undulating manifolds of fabric exposing both decorative surfaces of the panel (FIGS. 4 and 5). Multiple elements of complementary fabrics can be connected in wave-forms against the wall or as a divider screen as shown in FIGS. 3 and 4. Manufactured in free-form mosaic shapes, the fabric panels can be conjoined into light-weight three-dimensional “closed” structural units resembling large exterior metal sculptures in landscape architecture, as shown in FIG. 5.

The most important aspect of the current invention is its ease of manufacture, shipping, and storage, as elements are created and shipped as a flat planar element, and only bent to shape during installation. The current invention is easily manufactured on conventional sewing equipment, and can be conveniently shipped as a flat panel.

The current invention does not claim any particular means of connecting elements one to another, since any conventional means of connecting textiles may be appropriate, and there can be few installations of a scale that cannot be hand-connected by an individual in a short time.

The closest previous art-forms to the fabrication of the single manifold are from traditional sewing and millinery applications, with ribbon making, hat-shaping, and corset-making being the closest relative arts. In the first two of these cases the reinforcement stays are intended to be bendable by the end-user; yet the current invention differs from the fabric ribbon (as well as the hat) in the following regards. It can be applied to all types of fabric—whether coarse woolens or silks, brocades, damasks, cottons, synthetics or skins, the shape and size of a fabric is not constrained, where faces several feet square are easily supported. Channels for reinforcing stays may be added, and in many cases the entire face will be quilted to the interfacing in a decorative stitch. This does away with any need for heat-treatment and sizing to maintain stiffness of thinner fabrics, a problem encountered by fabric ribbons. The ability to create tessellations or mosaics of panels into “closed” sculptural shapes or into a continuous matrix hung freely from the ceiling or wall is also outside any use of the decorative fabric ribbon.

Several fabric paneling systems exist in which the fabric is attached to a substrate, as in the automobile industry, but these are not intended for user flexibility, nor intended for two-sided viewing. Applications of flexible fabric laminates face critical issues of stretch, bubbling and creasing; these are addressed by the current invention through the possibility of in situ bonding to the substrate by hand during installation.

### SUMMARY OF THE INVENTION

The current invention comprises a new use, or utility, for designer fabrics, wherein two-sided shapeable fabric manifolds can be manufactured and used as independent semi-rigid furnishing accessories, table-top sign or photo display holders, as well as hung as a free-hanging systems of shapeable composite fabric elements. In the first embodiment of the invention a two-sided shapeable fabric manifold is created by cutting two opposing faces of decorative fabric 1A and 1B, sewing and/or fusing each to an interfacing “stabilizer,” (1F and 1G) where the stabilizer is chosen appropriate to the physical qualities of the facing materials (such as leather, tapestry, cotton, satin, etcetera). After joining the two facing elements of the manifold, channels (dotted lines 1c1, 1e1, 1h1) are machine stitched to allow bendable to be inserted (1c2). Prior to closing the channels at the end, bendable stays (1C, 1E and 1H) are inserted into the channel, after which the channel is closed by hand stitching. The stays are not rigidly connected to one another at the ends, as shown by the gap at 1J, thus allowing the artist to freely adjust stay positions at installation. The preferred stay is the 8- to 4-gauge composite aluminum wire (3.25 mm-5.2 mm) used for sculptural armatures and floral arrangements. Facing stays, because they are less structural in nature, can be successfully created with plastic coated or uncoated 18 gauge stem wire used for silk flowers.

The second embodiment of the invention shown in FIG. 2 does not allow for as many artistic embellishments, but is an easy method for the mass-production or single fabrication of two-sided shapeable fabric manifolds. The two decorative fabric faces of the manifold 2A and 2F are cut together with allowance shown as the dotted line 2G for a hem around the bendable substrate 2B or 2C, which has already been cut in the desired shape of the manifold element. To this substrate (2B or 2C) is bonded a suitable adhesive to act as a fusible fabric interfacing (2D and 2E) such as Peltex® polyester interfacing stabilizer. The facing fabrics are then applied to either face of the manifold and fused to the interfacing with a hot iron or industrial hot-press. In certain cases, where it is ascertained that the manifold will have sharp bends or curls, areas of the facing material may be left unattached to the fusible interfacing until installation and bending, and then fused to the interfacing on the substrate with a hand-iron to avoid wrinkles on the inner face of the bend and stretching on the outer. There is no preferred substrate material, although aluminum or heavy tin can be used. For larger installations a substrate 2C of steel or aluminum mesh such as used for armatures in larger pottery or concrete structures is preferable, both for weight and to allow compound curves to be created without creasing.

Embodiments three through eight of the invention are distinct uses which allow the costliest decorative fabrics to be marketed to the public for their inherent artistic value in small affordable units, enhancing the perceived value of home fabrics as well as the conceptual use of textile in both interior architectural design and home décor. Different installation and ornamentation methods are entirely based upon an individual artist's conceptual uses.

### BRIEF DESCRIPTION OF THE DRAWINGS

FIG. 1 shows the first embodiment of the invention, termed a two-sided shapeable fabric manifold, wherein two opposing pieces of decorative fabric 1A and 1B are sewn and/or fused to interfacings 1F and 1G (as shown on FIG. 1.0). The two opposing pieces with interfacing attached are machine-stitched together as shown in FIG. 1.1. Channels are created during the process of machine-stitching, as shown along dotted lines 1c1,1e 1, and 1h1 on FIG. 1.0. Shapeable stays 1C, 1E, and 1H are inserted made of bendable wire (1c2) or rod. Rod may extend the entire edge of the manifold as shown in 1c1/1C, along a partial edge as in 1h1/1H, or to coincide with the fabric design across the face of the manifold as in 1e1/1E. The stay is freely inserted into the channel such that the fabric may be drawn together for decorative purpose as in 1D. Stays are not rigidly connected to one another at the ends, as shown in 1j, at the possible joint between stay 1H and 1C—thus allowing the artist to freely adjust stay positions at installation.

FIG. 2 shows the second embodiment of the invention in which the two opposing faces of decorative fabric 2A and 2F are bonded to adhesive interfacing materials 2D and 2E which have been previously bonded to two opposing surfaces of a bendable substrate 2B or 2C, and are hemmed together around the edge of the substrate along the dotted line 2G to fully enclose the manifold,

FIG. 3 shows how a 2-sided shapeable fabric manifold may be freely shaped and combined with other such manifolds by the artist. 3A in the drawing demonstrates the aesthetic property of adjustable stays such that fabric can be allowed to freely hang. 3B in the drawing shows a leaf-shaped manifold, demonstrating the construction of the primary invention in any shape the artist desires; 3b1 shows the use of a channel across the face of the manifold. 3C in the drawing shows how the entire construction may be freely hung to rotate, as in a mobile sculpture; 3c1, 3c2, 3c3, 3c4 demonstrate that shapeable fabric manifolds are connected at any point the artist desires to create a balance and aesthetic at the time of installation using any traditional method from the clothing, upholstery, or drapery trades which the artist deems aesthetically appropriate, such as drapery hooks, ribbon, chain, cord, button, hook and loop fasteners, etc.

FIG. 4 shows the fourth embodiment of the invention as an artistic paneling system which can be utilized as a screen (either sun and/or wind screen) or to separate areas in a room and which can be integrated with any form of lighting for special aesthetic effects. 4b1 in the drawing is the demonstration of how the invention expands the application of traditional textile crafts by integrating them into the larger functional application of the art-form (e.g. 4b1 shows knitted macramé while 4b2 shows quilting).

FIG. 5 shows the fifth embodiment of two-sided shapeable fabric manifolds connected together into a three-dimensional free-hanging sculptural form of any size, as depicted through the scale of people and double-doorway 5A.

FIG. 6 shows the sixth embodiment of the invention as a contoured fabric frame or bendable banner for two-dimensional graphic artwork (6A). 6B shows the location of internal bendable stays for creating the contour. 6C shows the facility for adding any traditional upholstery or drapery ornamentation, such as tassels or fringe. 6D depicts how fabric freely bunched along a stay for aesthetic effect.

FIG. 7 shows the seventh embodiment of the invention, hung alone in conjunction with fabric ornament 7A (a Décornament®), to serve as an alternative to a traditional swag window treatment.

FIG. 8 shows the eighth embodiment of the invention: 8A is a single heart-shaped semi-rigid fabric element being used as a decorative table-top tray.

FIG. 9 shows the third embodiment of the invention as either a free-standing or wall-mounted sign-holder or picture-holder. Illustration 9A shows a traditional wire stand used for signage in retail displays. Illustration 9B shows how the 2-sided fabric manifold may be bent to present the same signage backed by an ornate holder of tapestry, gilt brocade, velour, country cotton plaid or burlap. Illustration 9C shows how the rigid fabric framework of the 2-sided manifold may be attached to a wall with a common pushpin (9C2), while the sign or photo is held in place with common straight-pins (9C1). Illustration 9D shows the same fabric manifold bent to hold the sign or photograph simply by gravity, while being hung on the wall by picture-wire attached to the rigid fabric manifold with two ordinary drapery-hooks (9D1).

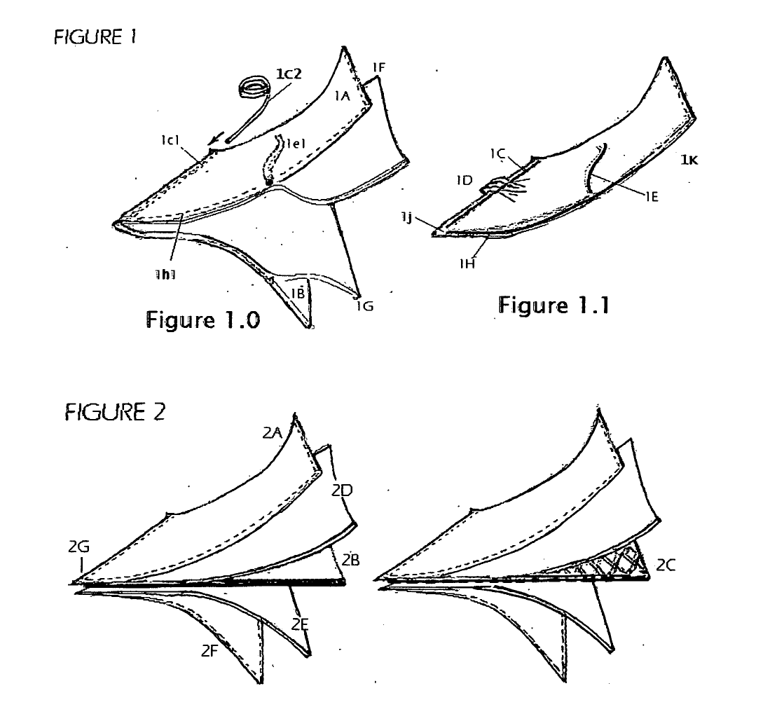

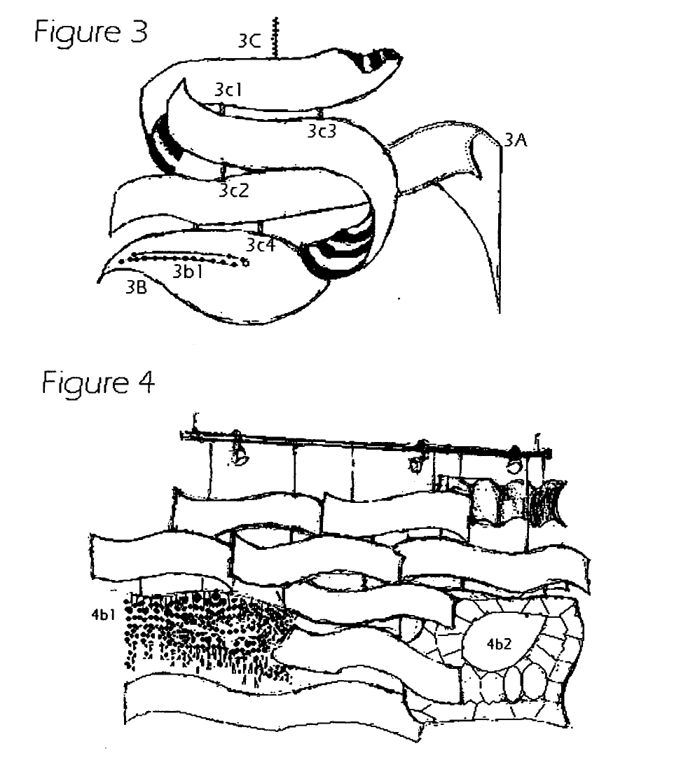

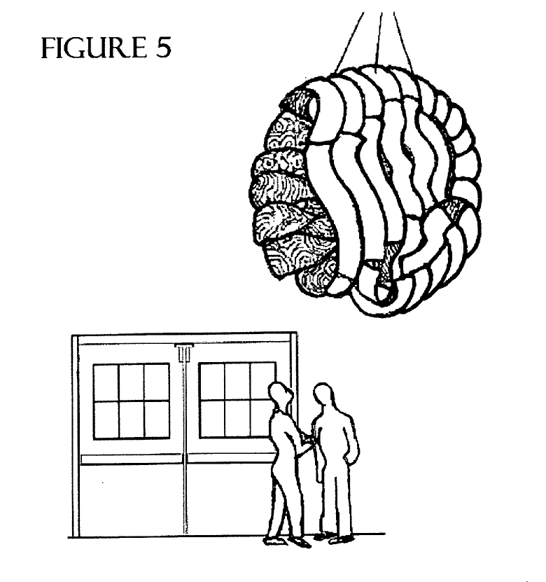

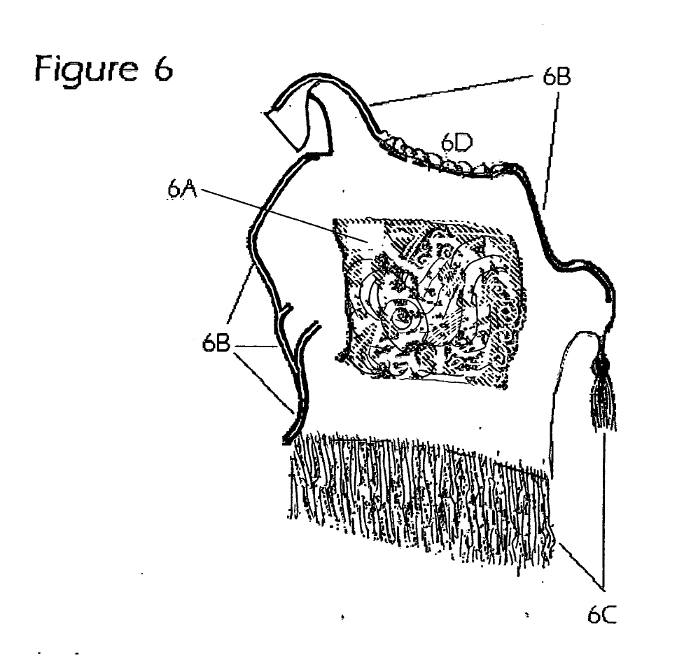

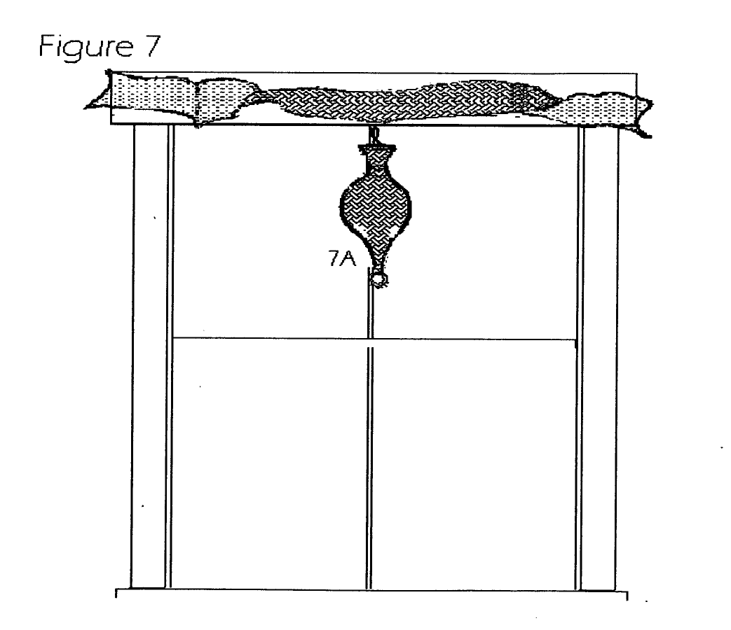

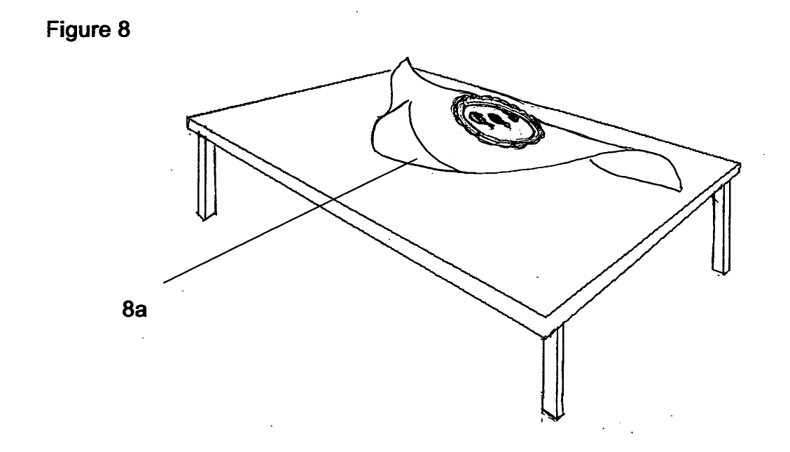

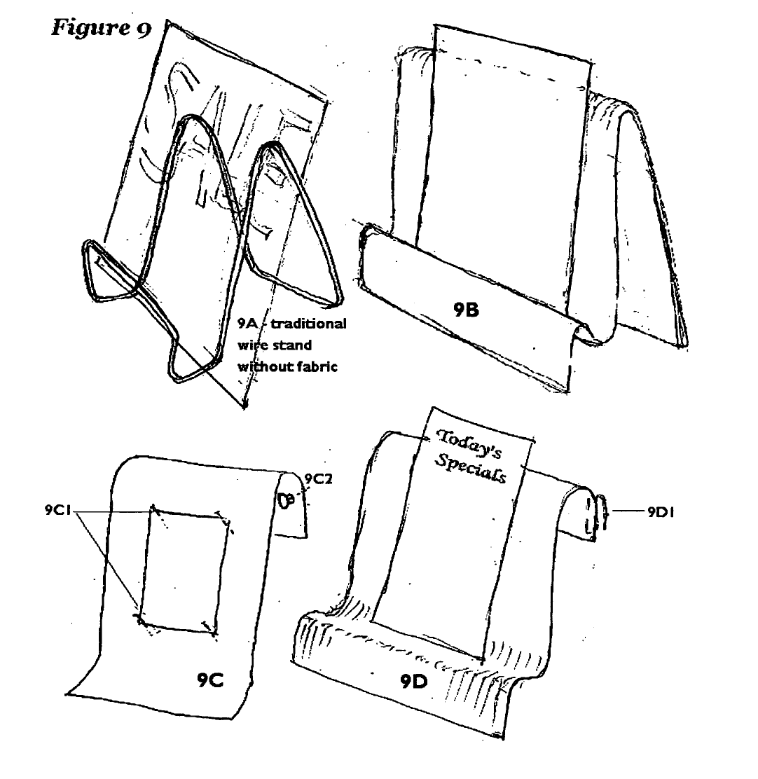

What is claimed is:

1. a two-sided shapeable fabric manifold which may be used alone or in combination with similar manifolds comprising

[symbol]

2. [symbol] two opposing faces, which may be termed a first face and a second face opposite to the first, which are made of a decorative material, such that
a. one or both faces of material of claim 2 may be made of decorative fabric,
b. one or both faces of material of claim 2 may be made of natural or man-made hide or snakeskin
c. one or both faces of material of claim 2 are of synthetic polymer
d. one or both faces of material of claim 2 constitute a quilting of multiple materials a-through-c, above
e. both faces of claim 2 can be impregnated with chemicals for the purposes of making the components resistant to environmental hazards, such as excessive sunlight, moisture, biological or insect infestation, sparks and flame.

3. The first embodiment of the invention allows two-sided shapeable fabric manifolds of claim 1 to be constructed such that each face of decorative material of claim 2 are sewn together with channels around the exterior hem or across either face, allowing shapeable stays to be inserted and freely secured in a fashion allowing certain aesthetic effects, such as:
a. the fabric may be gathered along the stay,
b. where the stay does not span the entire edge of the manifold, the fabric may be allowed to fall with gravity,
c. where the first face and the second face of claim 3 may be created with or without a stabilizing material depending on the weight of said material, and where a stabilizing material is used it may consist of padding (either natural or synthetic) or buckram (either natural or synthetic),
d. where the stays of claim 3 are made of bendable wire, rod, or wire ribbon, inserted into the channels constituting an independent reinforcement of the edge of the manifold, but not necessarily spanning the entire edge or seam according to the artistic intent, and where said flexible stays are not rigidly connected to other stays, nor fixed to the fabric other than by sewing closed the hem or channel at either end.
e. where the flexible stays of claim 3 are made of
i. a malleable metal that will hold a permanent shape when bent, or
ii. a flexible plastic that will hold a permanent shape when bent, or
iii. twisted rods of fiberglass that will hold a permanent shape when bent, or
iv. twisted rods of synthetic polymer fibers that will hold a permanent shape when bent, or
v. plastic-, urethane-, or similarly-coated composites of i-iv above.

4. The second embodiment of the invention allows two-sided shapeable fabric manifolds of claim 1 to be constructed such that the two opposing faces described in claim 2 are bonded to a potentially adhesive interfacing material which has been previously bonded to two opposing surfaces of a bendable substrate, and the opposing faces of decorative material are hemmed together around the edge of the substrate to fully enclose the manifold, and where
a. the bendable substrate may be a shapeable plate, laminate material, grid, or mesh, and
b. the adhesive interfacing material provides both stability support and “give” to the fabric-to-substrate bond, and is either heat-fusible to the fabric or otherwise designed to adhere to the fabric in a semi-adjustable manner.

5. The third embodiment of the invention allows individual two-sided shapeable fabric manifolds of claim 1 to be used as a table-top or wall-mounted commercial signage holder, or similarly, as a personal photograph-holder.

6. The fourth embodiment of the invention allows one or more two-sided shapeable fabric manifolds of claim 1 to be connected together and used as an artistic paneling system or screen to separate spatial areas, being connected to other elements utilizing any non-rigid mechanical means (such as drapery hooks and wire) that can be freely hung and integrated with lighting for aesthetic effects.

7. The fifth embodiment of the invention allows two-sided shapeable fabric manifolds of claim 1 to be connected together and used as a three-dimensional free-hanging light-weight sculptural form of any size.

8. The sixth embodiment of the invention allows two-sided shapeable fabric manifolds of claim 1 to be used as a substitute for a traditional wooden picture frame, such that paintings and 2-dimensional printed graphics on canvas or fabric are integrated into the textile elements of the structure.

9. The seventh embodiment of the invention allows two-sided shapeable (semi-rigid) fabric manifolds of claim 1 to be used as a window treatment in place of a traditional curtain swag.

10. The eighth embodiment of the invention takes advantage of the semi-rigid framework of the two-sided shapeable fabric manifolds of claim 1 to be used alone as decorative table-top tray or as an independent furnishing accessory.
